(19) United States
(12) Patent Application Publication
(10) Pub. No.: US 2013/0166311 A1
(43) Pub. Date: Jun. 27, 2013

(54) System and Method for Provisioning and Deploying a Virtual Appliance to Implement Enterprise Solutions

(71) Applicants: Michael Stock, Westminster, CO (US); David MacLeod, Greenwood Village, CO (US); Rob Campolieto, Greenwood Village, CO (US); Bill Monday, Greenwood Village, CO (US); Darin Osburn, Greenwood Village, CO (US); Tom Reising, Greenwood Village, CO (US); Michael Saxbury, Greenwood Village, CO (US); Brent Schmoker, Greenwood Village, CO (US); Calvin Griffin, Greenwood, CO (US); Monte Hartman, Erie, CO (US); Terry Mayer, Greenwood Village, CO (US)

(72) Inventors: Michael Stock, Westminster, CO (US); David MacLeod, Greenwood Village, CO (US); Rob Campolieto, Greenwood Village, CO (US); Bill Monday, Greenwood Village, CO (US); Darin Osburn, Greenwood Village, CO (US); Tom Reising, Greenwood Village, CO (US); Michael Saxbury, Greenwood Village, CO (US); Brent Schmoker, Greenwood Village, CO (US); Calvin Griffin, Greenwood, CO (US); Monte Hartman, Erie, CO (US); Terry Mayer, Greenwood Village, CO (US)

(73) Assignee: The TriZetto Group, Greenwood Village, CO (US)

(21) Appl. No.: 13/332,675

(22) Filed: Dec. 21, 2011

(51) Int. Cl. G06F 9/44; G06Q 50/22; G06Q 40/08

(52) U.S. Cl. 705/2; 717/170

(57) ABSTRACT

A reference architecture embodies a common, consistent, known best practice base reference architecture and configuration that may then be used for cloning out for the base of every customer environment. Given this base, the service provider is able to control the full functionality solution layer to provide the platform for consistent monitoring, patching, upgrading, etc. Accordingly, the service provider's application solution is an integrated appliance that can contain whatever is necessary at the solution layer to allow the service provider to remotely (or within the hosting center) support, maintain and gather key system metrics to promote optimal customer performance, decrease cost of implementation/support/ownership and vastly increase service offering base.

### BACKGROUND

1. Field of Embodiments

The embodiments are generally directed to an improved process for deploying and managing enterprise software solutions. More particular embodiments described herein are directed to the field of provisioning and deploying a base environment for implementation and management of an enterprise software solution using a virtual appliance.

2. Description of Related Art and Statement of Problem

The provisioning/deployment/integration/configuration of multiple enterprise application/business service solutions through various hardware and software configurations and the life-cycle of provisioning, deploying, maintaining, monitoring, patching, upgrading, etc. are often complex, contain numerous steps and handoffs and have been a point of historical pain for hosting and customer teams. Existing cycles utilize convoluted processes that included numerous steps, work orders, teams, and many days to provision the environment solution for the customer. Much of this work is done today as manual tasks, with 3 major potential risks: 1. the introduction of untracked or untraceable “needle in the haystack” defects or mistakes; 2. the strong potential for every base environment that is built being different than any other; and 3. steps (build, base business configuration, etc.) being duplicated manually time and again. An example of the number of steps and hand-offs are outlined in the prior art diagram at FIG. 1. This approach renders the ability to support, monitor and quickly duplicate the solution nearly impossible.

Accordingly, there is a need in the art for a solution that simplifies the processes for provisioning/deployment/integration/configuration of application/business service solutions, particularly multiple enterprise application/business service solutions.

### SUMMARY

In a first exemplary embodiment, a process for deploying enterprise software for implementing multiple objectives of a customer in a customer compatible environment is described. The process includes: establishing a reference architecture for the enterprise software; configuring one or more servers with operating system instructions and application instructions in accordance with the reference architecture to establish a base architecture for the enterprise software; storing the base architecture in a secure repository; generating one or more virtual applications in accordance with the base architecture, including one or more virtual machines commensurate with a number of configured one or more servers; deploying the one more virtual applications to the customer compatible environment, wherein a virtual version of the base architecture is available for use by the customer for implementing one or more of the multiple objectives; and monitoring by a monitoring system remote from and not associated with the customer, data associated with the base architecture in order to ensure that the deployed enterprise software and related hardware are capable of implementing the multiple objectives of a customer.

In a second exemplary embodiment, a process for executing enterprise software for implementing multiple objectives of a customer in a customer compatible environment is described. The process includes receiving at the customer compatible environment one or more virtual applications, wherein the one or more virtual applications represent a virtual version of a base architecture that has been previously configured by a service provider; customizing variablized items of the one or more virtual applications within the customer compatible environment using customer specific code to ensure that the one or more virtual applications are functional within the customer compatible environment in order to implement multiple objectives of the customer; and reporting system data back to a monitoring system of the service provider by the one or more virtual applications, wherein the monitoring system is able to track a source of the reported back system data based on one or more of the customized variablized items.

In a third exemplary embodiment a stand-alone physical structure including enterprise software for implementing multiple objectives of a customer in a customer compatible environment is described. The stand-alone physical structure includes: one or more virtual applications executed from a physical component of the stand-alone physical structure and including operating system instructions and application instructions in accordance with a base architecture for the enterprise software pre-established by a service provider; the one or more virtual applications including one or more virtual machines commensurate with a number of configured one or more servers as determined by the base architecture; and communications instructions programmed within a physical component of the stand-alone physical structure for facilitating communications with the customer compatible environment and a remote service provider monitoring system.

### BRIEF DESCRIPTION OF DRAWINGS

The following Figures are representative of various embodiments and are intended to be considered along with the written description provided herein.

FIG. 1 is a schematic showing generally the existing implementation teams and connections therebetween required in order to execute enterprise applications for a customer;

FIG. 2 is a schematic showing a process for establishing a gold image for deployment as a gold environment to multiple customers in accordance with an embodiment described herein;

FIG. 3 is a schematic showing a process for cloning an established gold environment to a customer working environment at multiple customer sites in accordance with an embodiment described herein;

FIG. 4 is a schematic of a different way of showing the process from FIG. 3 above.

FIG. 5 is a schematic showing the patching process for patching a gold image for deployed gold environments and customer working environments in accordance with an embodiment described herein;

FIG. 6 is a schematic showing the process for reporting to a service provider from applications deployed in customer working environments in accordance with an embodiment described herein;

FIG. 7 is a schematic showing the process for using self-awareness to monitor capacity requirements and spin up additional resources in accordance with an embodiment described herein;

FIG. 8 is a schematic showing an improved particular provisioning process and representative components in accordance with an embodiment described herein;

FIG. 9 is a schematic showing the configuration for a particular deployment configuration in accordance with an embodiment described herein;

FIG. 10 is a schematic showing additional details for the configuration generalized in FIG. 9 deployed with a particular application functionality in accordance with an embodiment described herein; and

FIG. 11 is a schematic showing additional details for the configuration generalized in FIG. 9 deployed with a particular application functionality in accordance with an embodiment described herein.

### DETAILED DESCRIPTION OF PREFERRED EMBODIMENTS

Generally, in the preferred embodiments, the solution to simplifying and shortening the lifecycle comprises, as a first step, creation and provisioning of a reference architecture. The reference architecture embodies a common, consistent, known best practice base reference architecture and configuration that may then be used for cloning out for the base of every customer environment. Given this base, the service provider is able to reduce introduced defectual risks and control the full functionality solution layer to provide the platform for consistent monitoring, patching, upgrading, etc. Accordingly, the service provider's application solution is an integrated appliance that can contain whatever is necessary at the solution layer to allow the service provider to remotely (or within the hosting center) support, maintain and gather key system metrics to promote optimal customer performance, decrease cost of implementation/support/ownership and vastly increase service offering base.

The preferred embodiments described herein recognize that there are steps that would necessarily be utilized in every instance of provisioning/deployment/configuration of an enterprise solution; independent of customer customization requirements. Accordingly, for example, all components of provisioning required to bring a solution to market, including but not limited to procurement, provisioning, build/installation, integration, testing, and support as well as required hardware, software, architecture, network, storage, application and business configuration are identified and then packaged into an executable that is used by virtualization software to deploy all components of a working business solution ready for a customer to start customizing quickly, easily and automated—as an exact copy every time. By presenting an exact copy or gold image of the entire solution layer—thus controlling what is in the solution layer—as the base of every customer environment out of a deployable package, this enables the service provider to further optimize the solution development lifecycle. The virtual appliance approach allows the service provider to auto deploy, e.g., in push button fashion, and update, business configuration, monitoring and business metrics capability, automated patching, “phone home” capability, self aware appliance functionality that allows such things as automated capacity growth and reduction. Further, the ability to deploy a fully integrated service provider suite into a customer's environment presents the ability to have all service provider solutions ready to go if/when a customer decides to “register” the functionality for use. The up-sell potential for this is substantial; in allowing customers to quickly turn on and try additional service provider functionality within their existing solution for “try and buy” add-ons.

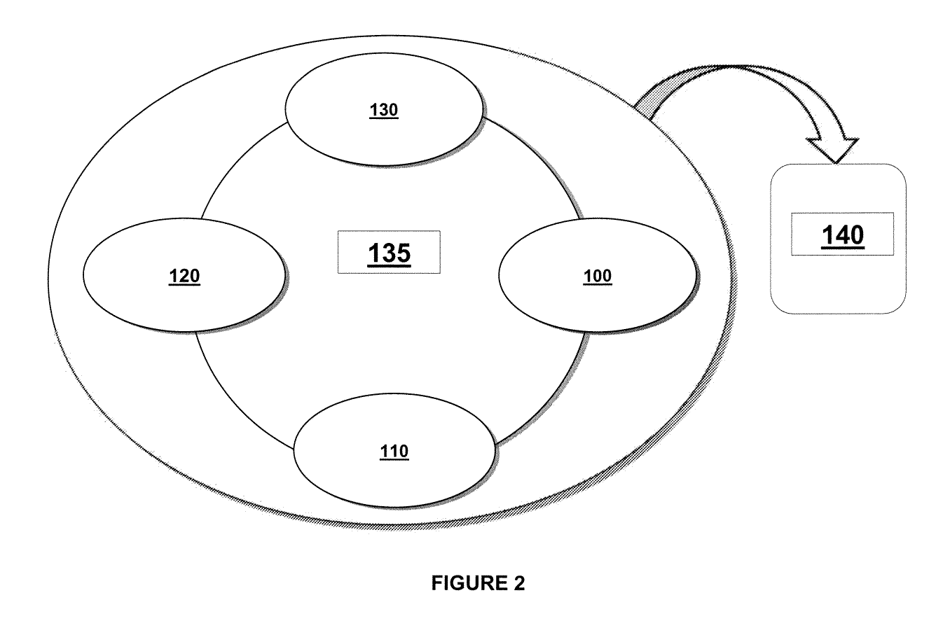

FIG. 2 is a schematic showing the cycle for creation of the gold image environment. The gold image environment is made up of various virtual machines (“VMs”). Each VM is built from the same base operating system (“OS”) and then system and application pre-requisites, core application components, and functional configurations are added producing individual gold images per VM. The reference architecture (“RA”) is an architectural blueprint of hardware, system resource, and resource objects associated with a particular software solution or application (hereafter “application”). The RA defines a consistent template used whenever a service provider's solution is procured, provisioned, installed, and integrated. JeOS (Just enough Operating System) refers to a customized operating system specific to a particular application. JeOS is designed to be used within an RA and virtual appliance and generally includes the pieces of an operating system required to support a particular application, including any other required third-party components. JeOS reduces appliance size and can increase security as compared to an application running under a full general purpose OS. Accordingly, the system pre-requisites, e.g., RA, JeOS 100; specific application prerequisites 110; the application 120 and base server image 130 make up a golden system or environment image (“gold image”) 135. The gold image is what a limited availability (“LA”) release might consist of when released to hosting. In accordance with the virtual application process described herein, the gold image is used to clone the environment and produce an identical virtual appliance across any number of different customers and customer platforms.

Virtual Appliances (vApps) are pre-built software solutions, comprised of one or more virtual machines built from an RA, which are packaged, updated, maintained and managed as a single virtual object. Unlike a traditional hardware appliance, vApps let customers easily acquire, deploy and manage, pre-integrated solution stacks. The vApp speeds up time to value and simplifies software development, distribution, and management.

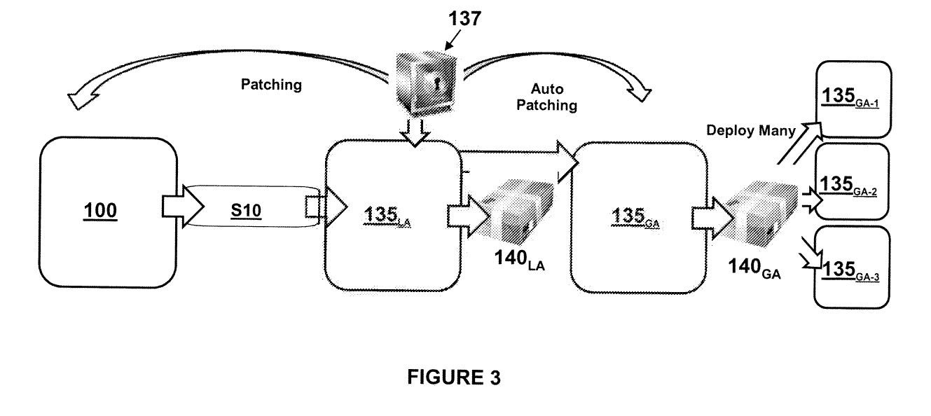

Referring to FIG. 3, an exemplary embodiment of the vApp packaging process from product development to production deployment is shown via schematic. The overall packaging process generally follows the open virtualization format (OVF) which is an open standard for packaging and distributing virtual appliances, i.e., software for running on virtual machines (e.g., servers). More particularly, within the agreed upon RA environment 100, various JeOS and application components/functionality are configured into appropriate servers S10. Such post installation, pre limited availability release configuration includes, but is not limited to: installation of third party applications and content; system, business, report, appliance monitoring parameters, appliance management parameters and appliance self-awareness configuration. The result of post installation configuration S10 to appropriate servers in the RA environment 100 is the gold image environment 135_{LA}. The gold environment code is stored in an appropriate code repository 137 with applicable version controls and security and is used to generate the limited availability (LA) vApp gold image environment 140_{LA} and eventually general availability (GA) gold image 135_{GA} and vApp gold image environment 140_{GA}. Either the LA or GA vApps are available for immediate deployment of duplicate and identical gold image environments 135_{GA-1}, 135_{GA-2} and 135_{GA-3} into various virtual base infrastructure targets including, but not limited to, a service provider network or, alternatively, into the customer or cloud vendor network and domain destination space where the applications will reside.

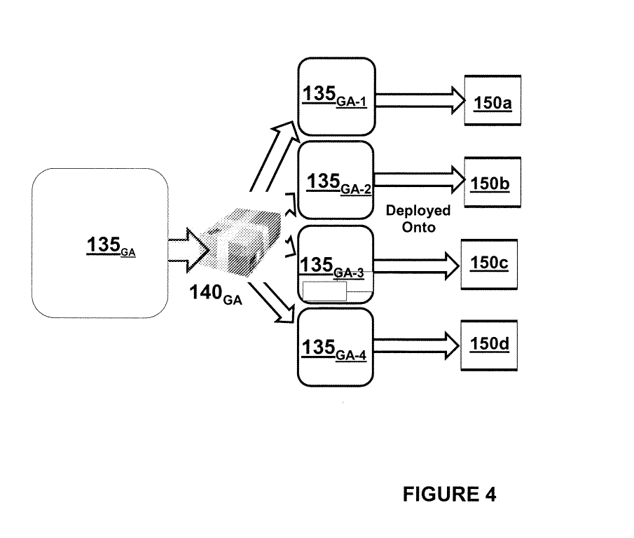

Referring to FIG. 4, exemplary deployment scenarios are illustrated via schematic. More particularly the general availability (GA) gold image 135_{GA} is deployed by vApp gold image environment 140_{GA} to provide identical gold image environments at any number of different virtual base infrastructure targets 135_{GA-1}, 135_{GA-2}, 135_{GA-3} and 135_{GA-4}. For example, 135_{GA-1} is deployed to a virtual infrastructure that is hosted by the service provider 150a; 135_{GA-2} is deployed to a physical appliance infrastructure that at the customer 150b; 135_{GA-3} is deployed to a customer's virtual infrastructure 150c; and 135_{GA-4} is deployed to a cloud vendor (neither host nor customer) infrastructure 150d.

Once the vApp, an executable used by virtualization software programs, is deployed, it is powered on, i.e., executed automatically and accessible for a certain level of customization by the customer via, e.g., a web-based interface or within the virtualization software program executing the vApp. While a vApp is powering on, custom code is used to change variablized items such as server names, IP addresses, specific references to network domains, user accounts, passwords, etc. to match those items as they exist in the destination location. The underlying variablized information is serialized within the vApp clone and no gold code image software is altered during this process. Once the vApp power on phase is complete, the virtual machines are running in a destination location and it is a fully functional environment separate from the gold image, ready for customer use.

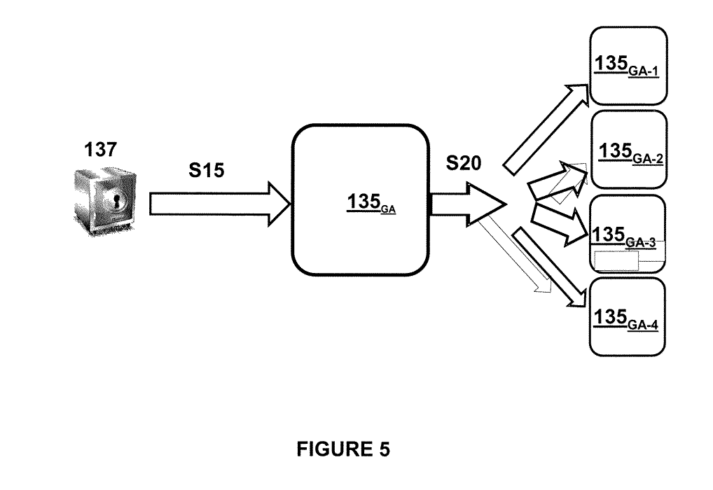

Referring to FIG. 5, the deployed vApps (e.g., 135_{GA-1}, 135_{GA-2}, 135_{GA-3} and 135_{GA-4}), also referred to as child vApps, are maintained in an on going process through receipt of approved updates to the parent gold image via an auto patching process, wherein the parent gold image 135_{GA} is patched S15 based on the latest approved patches in the code repository 137 and the approved patches are automatically presented to the child vApps in a pub-sub process S20. The patching processes are described with reference to a specific example below.

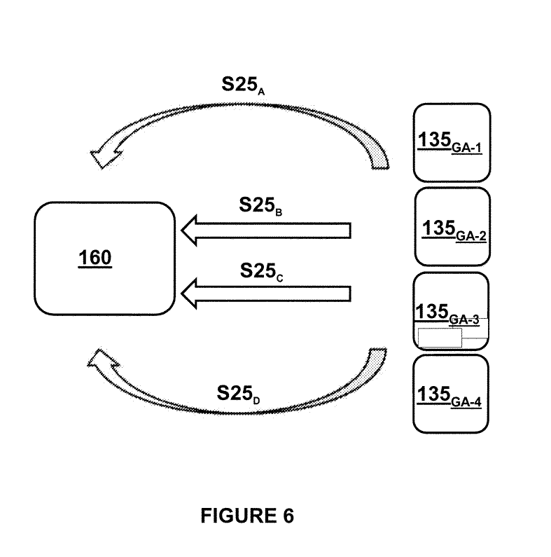

Referring to FIG. 6, patches may result from the implementation of a vApp monitoring and management process S25_{A}, S25_{B}, S25_{C} and S25_{D}, whereby the child vApps (e.g., 135_{GA-1}, 135_{GA-2}, 135_{GA-3} and 135_{GA-4}) independently report back system data to the service provider's monitoring center 160. Such data may include, e.g., health levels via memory, central processing unit (cpu), disk space, input/output (I/O), network latency, event messages (e.g., application, security, system); patch levels/software versions; VM server quantity and type, server up time, batch processing times; key solution business data; and charge back data for adding software or system resources. The vApp self-awareness framework being built would handle the communication channels using proven common standard protocols such as SSL or web service technologies. The appliance monitor was configured into the parent gold image and thus the child vApp as part of the post-RA installation configuration process S10 (see FIG. 2).

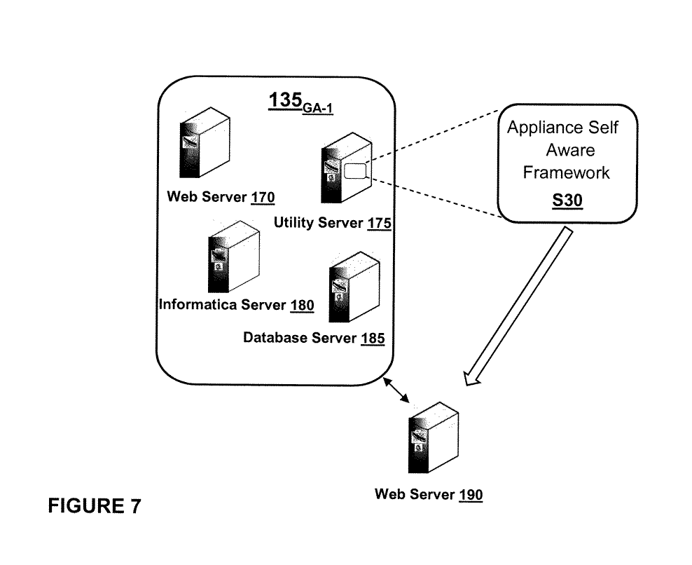

Referring to FIG. 7, another feature of the gold image is the vApp self-awareness framework and process S30, whereby the child vApps (e.g., 135_{GA-1}, 135_{GA-2}, 135_{GA-3} and 135_{GA-4}) are able to realize capacity limitations and self correct by dynamically spinning up added (available) capacity. By way of very specific example, child vApps 135_{GA-1} includes four virtual machine servers in accordance with the parent gold image 135_{GA}, e.g., a web server 170, utility server 175, Informatica server 180 and database server 185. If child vApp 135_{GA-1} recognizes that, for example, current web server 170 capacity is insufficient using the pre-configured self awareness functionality, the vApp 135_{GA-1} is able to spin up a second pre-configured web server 190 and load balance into the solution.

As described herein, while the process and system for building and implementing a vApp has been described without application to a particular business implementation, a description of a real-world application is useful to highlight the far reaching benefits of the solution set forth in the preferred embodiments. Current assignee, The TriZetto Group (“TZG”), offers numerous software-based products and suites of products and services in the health care field. For example, TZG offers market-leading enterprise-wide software solutions for health plan administration, e.g., FACETs and QNXT, which are core administration systems for managing all aspects of health plan administration including medical and dental claim processing; consumer-directed health capabilities with advanced HSA/HRA functionality; claim-repricing and external-billing capabilities; and capabilities for integrated care management, care planning, predictive modeling, and branching logic. In addition to core systems, TZG also offers myriad of applications for integration with core systems, both TZG and non-TZG. By way of particular example, the NetworX suite of products provide for automation of claims pricing across one ore more core systems and applications (NetworX Pricer), contract modeling based on historical and hypothetical claims data and rates/terms (NetworX Modeler), modeling contract proposals against projected spend (NetworX Modeler Analytics) and payment bundling administration (NetworX Payment). The CareAdvance applications provide for management of an organization's care management programs. The CareAdvance Enterprise (CAE) application automates care management workflows and personalizes member communications in support of utilization, case, disease and population management through secure collection and aggregation of member data in a single repository, so that information can be shared by all entities involved in the member's care.

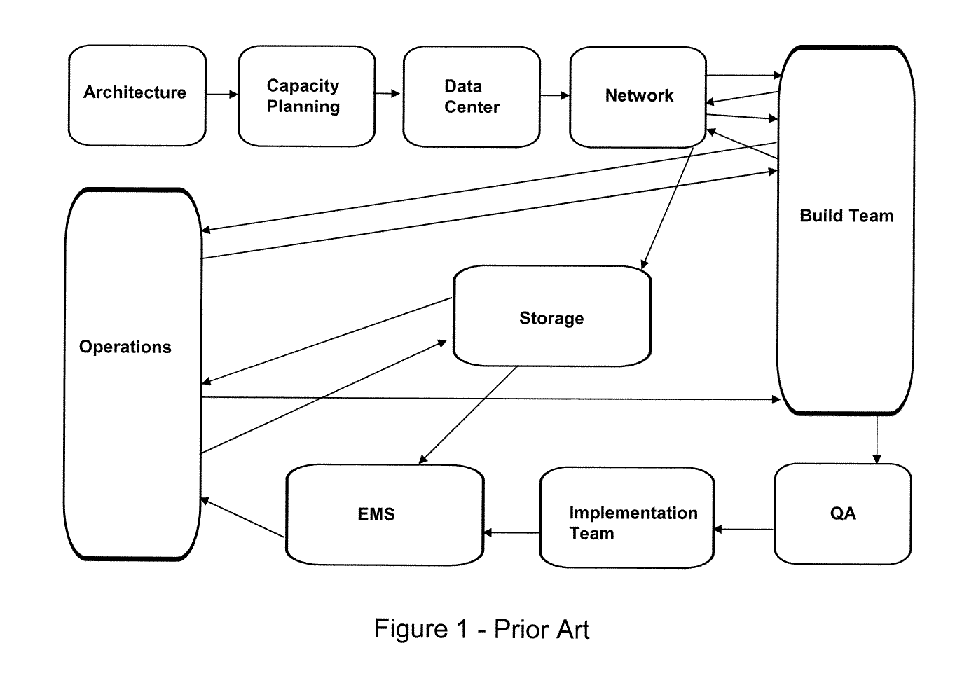

With respect to the vApp embodiments described herein and by way of particular example, using prior art methodologies, a typical CAE provisioning cycle, that is, the amount of time it takes TZG to provision the CAE solution for a new customer, took on average 78 days. The process typically included 22 main steps, 13 work orders, and 10 teams to provision the typical 3 environment solution for the customer. Much of this work is done as manual tasks, with the end result being the strong potential for every base environment that is built being different than any other and steps (build, base business configuration, etc.) being duplicated manually time and again (see FIG. 1). This approach renders the ability to support, monitor and quickly duplicate the solution nearly impossible.

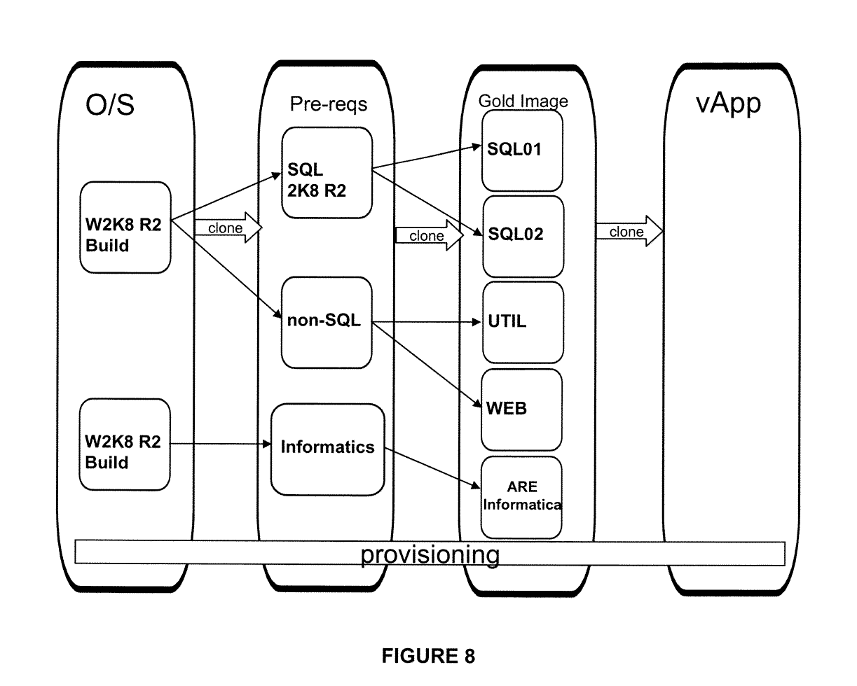

Referring to FIG. 8, by applying the vApp methodologies described herein, provisioning of a representative CAE application is substantially simplified once a parent (or base) gold image is established. As shown in the schematic, for this solution, they start with two base OS images (or templates), which are delivered by a hosting architecture team and then maintained by the hosting build team. These templates are used for nearly every server build. Next, the OS images are overlayed with the pre-requisites needed for the overlying applications. Depending on the application solution, the number of pre-requisite images will vary. In this example, for the specific CAE, all CAE essentials servers are based off of one of three pre-requisite templates (W2K9 R2 SQL, W2K9 R2 Non-SQL, and W2K3 Informatica). From the pre-requisite image layer, the provisioning process moves to the application based images (CAE in this case). The individual application installations are completed on one of the three (for this case) pre-requisite images for an end result of the final application solution server footprint. This set of application images becomes the application solution's gold image set that will be used for packaging into the virtual application (vApp). Every CAE environment deployed utilizing the vApp package that was created will look 100% like this set of server images. The vApp is only used as an object for deploying initial environments in a faster, simpler, and more consistent manner.

For server image version control the hosting build team obtains build infrastructure and either leaves the golden images up and running as a single environment instance or automates the spinning up and down of the environment during patching cycles. It is understood that re-builds of the base gold images, and thus re-packaging of vApps, will be necessary in view of changes to business functionality and technical requirements. This could be accomplished on a pre-determined schedule, e.g., quarterly, or in response to a particularly heavy volume of post-deployment patches which warrant off schedule re-build.

Patching for the virtual application and its images can be broken out into the two, distinct categories: architectural (i.e. OS, DBMS, etc.) and application (i.e., for CAE this includes CareAdvance, Informatica, etc.). Patches are never applied to the vApp. Instead, the vApp is repackaged for future deployments and the environments previously deployed have patches applied to the golden image set. The gold images will be utilized as the server set to package into the virtual application. Because of this, it will be critical to treat this image set as a production-like environment, utilizing back-ups, change control and limited access. Once the first version of the virtual application is created and utilized for production deployments, a re-build and version control methodology is going to need to be invoked. From a re-build perspective, the recommendation is to perform a re-build of the virtual application package on a quarterly basis. The exception to this would be if there is a heavy enough volume of post deployment patches to warrant an off-schedule re-build. This will be covered in additional detail when patching is discussed below. Patching and maintenance will occur to the gold image and then the vApp will be re-packaged from that gold image and re-deployed into the customer environment.

The gold image environment deployed as a vApp offers customers the ability to customize use of the available applications. Certain customers may wish to use all of the available applications while others may only require certain applications, but the vApp gold image environment presents a base menu which is readily available for purchase and configuration. The vApp facilitates quicker time to use for the customer.

Further to the specific application, the CAE gold image environment includes reporting capabilities (see FIG. 6) that are not limited to technical metric reporting, but also include reporting of business related data that the service provider may be able to analyze and provide feedback to individual customers. For example, if customer reports data back to the service provider that indicates that a customer supported health plan has identified one percent of their population as being pre-diabetic, but industry statistics tell us that they should have found three percent of their population is pre-diabetic, and so the service provider monitoring system could separately contact the customer regarding this potential discrepancy. Accordingly, this is not necessarily a situation where a patch to the gold image would be appropriate, but instead highlights an additional value-add that stems from the ability to essentially monitor customers' technical and business use and requirements through service-provider specific applications overlayed onto base OS images and deployed via vApp.

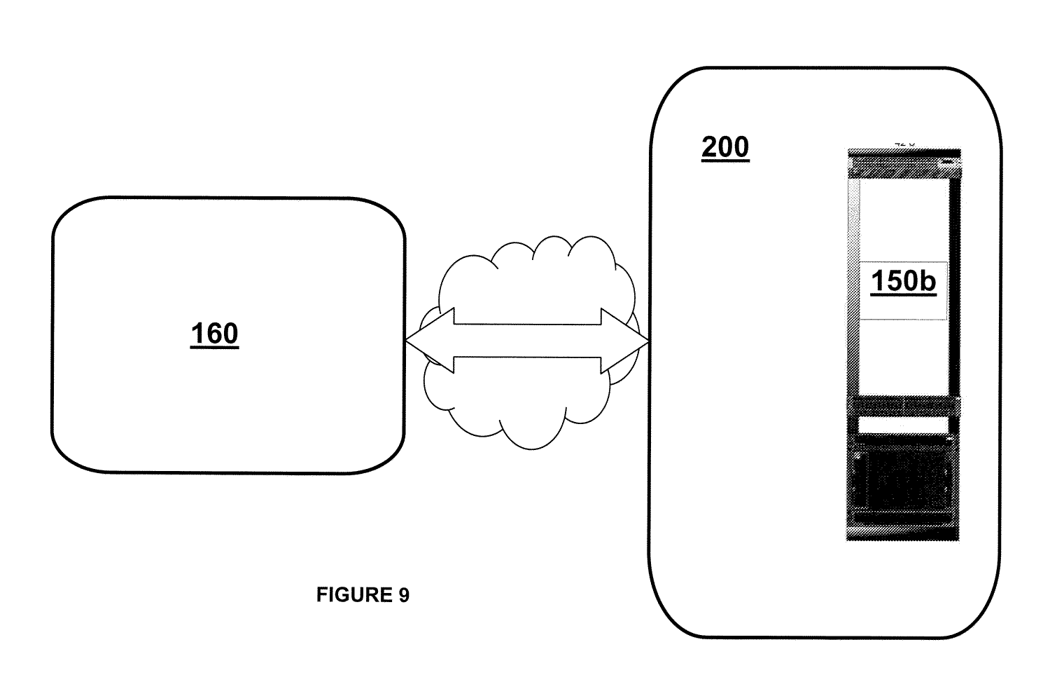

This is a very specific example and implementation of the generalized process of FIG. 2 described above, but illustrates the preferred methodologies. 100371 Referring to FIG. 9 in accordance with the description with respect to FIG. 4, a specific vApp deployment situation includes deployment of a physical structure 150b that includes the vApp at a customer site, e.g., on the customer data center floor 200. In a particular implementation, the fully enclosed, stand alone appliance is pre-built in a single hardware enclosure, loaded with the software, all processing units, storage, firewalls, utilities (e.g., FTP and SFTP), and monitoring systems, e.g., for monitoring software and hardware. The appliance utilizes, e.g., the IBM System Director, to host the backup and recovery utility agents in use by the customer data center, thus leveraging the existing backup infrastructure. The appliance is shipped in a rack, e.g., standard IBM 42u or the like, and is fully self-contained. To power up, all that is required is power and internet connectivity. Through the internet connectivity, the service provider 160 is able to remotely access the appliance and to provide remote applications management. In the context of health-related enterprises, this embodiment provides a simple, straightforward solution that is agnostic to the connected core systems, e.g., claim processing system, eliminates the health plan's needs to implement additional and possibly unfamiliar hardware, and allows a service provider to provide remote application management on a platform that leverages existing hosting standards, e.g., back-up processes.

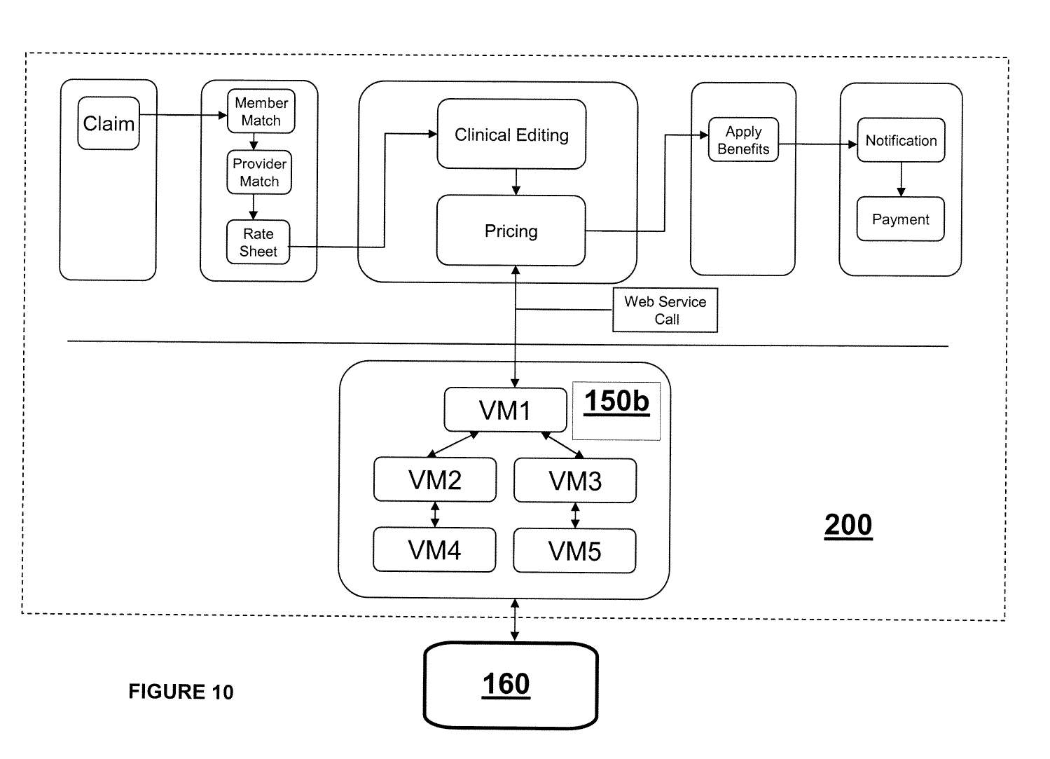

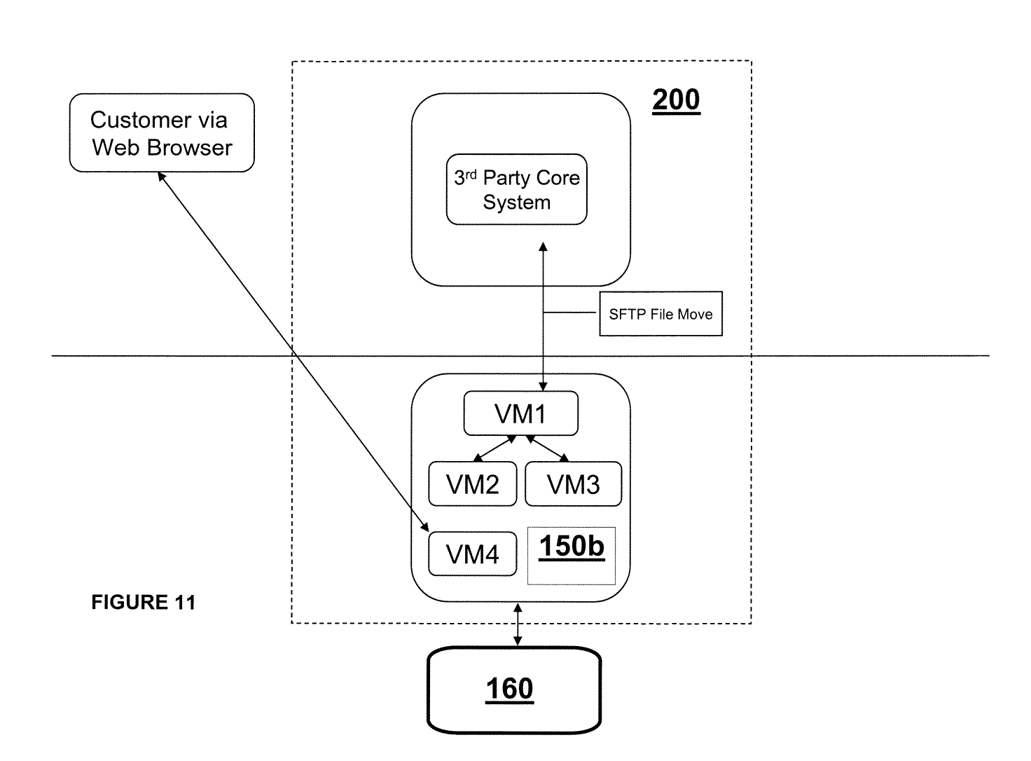

FIGS. 10 and 11 are schematics showing specific implementations of the vApp stand-alone appliance in accordance with, for example, CAE and NetworX interfaces and functionality. More particularly, FIGS. 10 and 11 exemplify the use of the vApp stand-alone appliance to implement and manage products such as NetworX Pricer and CAE with non-TZG, e.g., competitor core systems. The vApp stand-alone appliance approach allows TZG to deploy these products literally on the data center floor of a core system competitor without exposing TZGs product functionality beyond the basic integration channels (e.g., web service calls, file formats, etc.). The vApp stand-alone appliance is fully self contained and is flexible enough in the design and specifications to allow modifications required for customer specific requirements, specifically volume and throughput requirements. This solution represents essentially a “black box” onto which non-TZG core systems place pricing requests, and receive back changes to claims service lines that can be consumed by the non-TZG core system.

Referring to FIG. 10, the schematic illustrates the vApp stand-alone appliance 150b; including VMs for implementing the NetworX Pricer functionality, that is physically proximate to third-party components for implementing core system functionality, e.g., claim intake, member match and rate selection, editing and pricing, benefits application, notification and payment. The NetworX pricer functionality within the vApp stand-alone appliance responds to web service calls from the pricer component of the third-party core system. The firewall maintained by the vApp stand-alone appliance 150b limits communications with the third party system while allowing the service provider 160 to remotely access the appliance and to provide remote applications management.

Referring to FIG. 11, the schematic illustrates the vApp stand-alone appliance 150b, including VMs for implementing the CAE functionality, that is physically proximate to a third-party core system. As shown, the third party core system is imported to and extracted from the CAE vApp stand-alone appliance 150b in accordance with, e.g., an SFTP (secure file transfer protocol) file move. Customers are able to access functionality and programs offered by CAE via a web interface. As described with reference to FIG. 10, management of the vApp stand-alone appliance is performed remotely by the service provider 160.

The embodiments described herein provide for the ability to deploy a fully configured solutions layer in a consistent, configured, reference architecture and further facilitate, among other improvements: heightened business functionality within the deployed footprint by controlling the solutions layer; immediate provisioning of a base set of consistent business configuration out of the box, which both decreases historical time manually configuring the base for every customer and, provides a consistent base set across the customer base that provides a functional system out of the box; pre-tuned system parameters that are set to service providers known best practice settings through the automated deployment; inclusion of auto patching of customer environments by allowing the deployed appliance to poll for the latest patches; remote monitoring and health checks through inclusion of “phone home” capabilities that can provide information regarding system health (i.e. CPU, memory, etc.), performance health (i.e. transaction UI 90%, etc.) and business metrics (i.e. for TZG-specifically, claims processed per minute, providers under management, etc.); upgrading and support (in hosting and remotely), i.e., having a consistent footprint allows for the ability to more effectively support and upgrade a customer's environment with automation and quicker time to resolution of issues; self aware appliance capabilities such as automated capacity grown and reduction based on key system metrics.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

Some exemplary embodiments described herein are described as software executed on at least one processor, though it is understood that embodiments can be configured in other ways and retain functionality. The embodiments can be implemented on known devices such as a server, a personal computer, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

Unless specifically described for a particular implementation, it is to be appreciated that the various components of the technology can be located at distant portions of a distributed network and/or the internet, or within a dedicated secure, unsecured and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, unless specifically described for a particular implementation, it should be appreciated that the various links connecting the elements can be wired or wireless links, or any combination thereof, or any other known or later developed element(s) that is capable of supplying and/or communicating data to and from the connected elements.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

1. A process for deploying enterprise software for implementing multiple objectives of a customer in a customer compatible environment comprising:
establishing a reference architecture for the enterprise software;
configuring one or more servers with operating system instructions and application instructions in accordance with the reference architecture to establish a base architecture for the enterprise software;
storing the base architecture in a secure repository;
generating one or more virtual applications in accordance with the base architecture, including one or more virtual machines commensurate with a number of configured one or more servers;
deploying the one more virtual applications to the customer compatible environment, wherein a virtual version of the base architecture is available for use by the customer for implementing one or more of the multiple objectives; and
monitoring by a monitoring system remote from and not associated with the customer, data associated with the base architecture in order to ensure that the deployed enterprise software and related hardware are capable of implementing the multiple objectives of a customer.

2. A process according to claim 1 further comprising:
accepting reporting data about the base architecture by at least one of the one or more virtual applications and sending accepted reporting data to the monitoring system;
determining from the accepted reporting data at the monitoring system if a patch to the base architecture is required; and
if required, patching the base architecture for the enterprise software in accordance with the accepted reporting data;
storing the patched base architecture in the secure repository;
generating one or more patched virtual applications in accordance with the patched base architecture; and
deploying the one more patched virtual applications to the customer compatible environment in accordance with a scheduled maintenance deployment.

3. A process according to claim 1 wherein deploying the one or more virtual applications comprises:
deploying a physical structure including the one or more virtual applications to a customer location.

4. A process according to claim 3, further comprising:
accepting reporting data about the base architecture by at least one of the one or more virtual applications and sending accepted reporting data to the monitoring system;
determining from the accepted reporting data at the monitoring system if a patch to the base architecture is required; and
if required, patching the base architecture for the enterprise software in accordance with the accepted reporting data;
storing the patched base architecture in the secure repository;
generating one or more patched virtual applications in accordance with the patched base architecture; and
deploying the one more patched virtual applications to the physical structure in accordance with a scheduled maintenance deployment.

5. The process according to claim 1, wherein a communication channel for the deploying and monitoring steps is a web-based technology.

6. The process according to claim 2, wherein the reporting data includes one or more of customer system health data; customer system patch or version data; and customer specific business requirements data.

7. The process according to claim 2, further comprising deploying the one more virtual applications to multiple customer compatible environments and accepting reporting data from one or more virtual applications in multiple customer compatible environments.

8. A process for executing enterprise software for implementing multiple objectives of a customer in a customer compatible environment comprising:
receiving at the customer compatible environment one or more virtual applications, wherein the one or more virtual applications represent a virtual version of a base architecture that has been previously configured by a service provider;
customizing variablized items of the one or more virtual applications within the customer compatible environment using customer specific code to ensure that the one or more virtual applications are functional within the customer compatible environment in order to implement multiple objectives of the customer; and
reporting system data back to a monitoring system of the service provider by the one or more virtual applications, wherein the monitoring system is able to track a source of the reported back system data based on one or more of the customized variablized items.

9. The process according to claim 8, wherein the variablized items include at least one of the following group consisting of customer server names, customer IP addresses, customer network domain data, customer user account data, and customer password data.

10. The process according to claim 8, wherein reported back system data includes one or more of customer system health data; customer system patch or version data; and customer specific business requirements data.

11. The process according to claim 8, further comprising:
receiving one more patched virtual applications at the customer compatible environment in accordance with a scheduled maintenance deployment, wherein the patches to the one or more virtual applications were implemented by the service provide in response to reported back system data.

12. The process according to claim 8, wherein a communication channel for the receiving and reporting steps is a web-based technology.

13. The process according to claim 8, further comprising determining by the one or more virtual applications that one or more additional resources are required and automatically engaging the one or more additional resources within the customer compatible environment.

14. A stand-alone physical structure including enterprise software for implementing multiple objectives of a customer in a customer compatible environment comprising:
one or more virtual applications executed from a physical component of the stand-alone physical structure and including operating system instructions and application instructions in accordance with a base architecture for the enterprise software pre-established by a service provider;
the one or more virtual applications including one or more virtual machines commensurate with a number of configured one or more servers as determined by the base architecture; and
communications instructions programmed within a physical component of the stand-alone physical structure for facilitating communications with the customer compatible environment and a remote service provider monitoring system.

15. The stand-alone physical structure of claim 14, wherein operation and system parameters of the one or more virtual appliances and the base architecture are not accessible to the customer compatible environment.

16. The stand-alone physical structure of claim 14, wherein the one or more virtual appliances implement a medical claim pricing function in response to a request from the customer compatible environment.

17. The stand-alone physical structure of claim 16, wherein the request from the customer compatible environment includes medical claim data required for implementing the medical claim pricing function by the one or more virtual appliances.

18. The stand-alone physical structure of claim 16, wherein the request from the customer compatible environment is in the format of a web service call.
